(19) United States
(12) Patent Application Publication
(10) Pub. No.: US 2022/0407355 A1
(43) Pub. Date: Dec. 22, 2022

(54) DUAL-FREQUENCY WIRELESS CHARGING SYSTEMS

(71) Applicant: Apple Inc., Cupertino, CA (US)

(72) Inventors: Makiko Kawamura Brzezinski, Santa Clara, CA (US); Eric X. Zhou, San Jose, CA (US); Brennan K. Vanden Hoek, Bear Valley, CA (US); Saining Ren, Auckland (NZ)

(73) Assignee: Apple Inc., Cupertino, CA (US)

(21) Appl. No.: 17/655,329

(22) Filed: Mar. 17, 2022

Related U.S. Application Data
(60) Provisional application No. 63/202,730, filed on Jun. 22, 2021.

(51) Int. Cl. H02J 50/10; H02J 50/00; H02J 50/70; H02J 7/00; H01F 27/28; H01F 38/14

(52) U.S. Cl. CPC H02J 50/10; H02J 50/005; H02J 50/70; H02J 7/0042; H01F 27/2823; H01F 38/14; H01F 27/2885

(57) ABSTRACT

In a wireless charging system, a transmitter coil of a wireless charger device and a receiver coil of a portable electronic device can operate at either of two different operating frequencies. The low frequency can be in a range from about 300 kHz to about 400 kHz, and the high frequency can be in a range from about 1 MHz to about 2 MHz. To provide efficient charging at both frequencies, the transmitter and receiver coils can be formed from a compound, or multi-stranded, wire.

### CROSS-REFERENCES TO RELATED APPLICATIONS

This application claims priority to U.S. Provisional Application No. 63/202,730, filed on Jun. 22, 2021, entitled “Dual-Frequency Wireless Charging Systems,” the disclosure of which is incorporated herein by reference.

### TECHNICAL FIELD

This disclosure relates generally to inductive charging systems and in particular to multi-frequency wireless charging systems.

### BACKGROUND

Portable electronic devices (e.g., mobile phones, media players, electronic watches, and the like) operate when there is charge stored in their batteries. Some portable electronic devices include a rechargeable battery that can be recharged by coupling the portable electronic device to a power source through a physical connection, such as through a charging cord. Using a charging cord to charge a battery in a portable electronic device, however, requires the portable electronic device to be physically tethered to a power outlet. Additionally, using a charging cord requires the mobile device to have a connector, typically a receptacle connector, configured to mate with a connector, typically a plug connector, of the charging cord. The receptacle connector includes a cavity in the portable electronic device that provides an avenue via which dust and moisture can intrude and damage the device. Further, a user of the portable electronic device has to physically connect the charging cable to the receptacle connector in order to charge the battery.

To avoid such shortcomings, wireless charging technologies (also referred to as inductive charging technologies) have been developed that exploit electromagnetic induction to charge portable electronic devices without the need for a charging cord. For example, some portable electronic devices can be recharged by merely resting the device on a charging surface of a wireless charger device. A transmitter coil disposed below the charging surface is driven with an alternating current that produces a time-varying magnetic flux that induces a current in a corresponding receiver coil in the portable electronic device. The induced current can be used by the portable electronic device to charge its internal battery.

### SUMMARY

According to some embodiments of the present invention, the transmitter coil of a wireless charger device can operate at either of two different operating frequencies, referred to herein as a “low” frequency and a “high” frequency. The low frequency can be in a range from about 300 kHz to about 400 kHz (e.g., about 326 kHz in some embodiments), and the high frequency can be in a range from about 1 MHz to about 2 MHz (e.g., about 1.78 MHz in some embodiments). Similarly, according to some embodiments of the present invention, the receiver coil of an electronic device that can be charged from a wireless charging device can operate at either the high or low frequency. To provide efficient charging at both frequencies, the transmitter and receiver coils can be formed from a compound, or multi-stranded, wire. For instance, a compound wire in a transmitter coil can include a number of strands, where each strand can be a thin (e.g., 30 μm diameter) strand of conductive (e.g., copper) wire having an electrically insulating outer layer. Strands can be twisted around each other to form a set of basic bundles; groups of basic bundles can be twisted around each other to form a set of compound bundles; and the compound bundles can be twisted around each other to form the compound wire. In some embodiments, each basic bundle can include four strands, each compound bundle can include four basic bundles, and the compound wire can include seven compound bundles. As another example, a compound wire in a receiver coil can include a number of strands, where each strand can be a thin (e.g., 30 μm diameter) strand of conductive (e.g., copper) wire having an electrically insulating outer layer. Strands can be twisted around each other to form a set of bundles, and the bundles can be twisted around each other to form the compound wire. In some embodiments, each bundle can include six strands, and the compound wire can include six bundles.

The following detailed description, together with the accompanying drawings, will provide a better understanding of the nature and advantages of the claimed invention.

### BRIEF DESCRIPTION OF THE DRAWINGS

FIG. 1 shows a perspective view of an electronic device and a wireless charger device according to some embodiments.

FIG. 2 shows an exploded view of a wireless charger device according to some embodiments.

FIG. 3 shows an exploded view of a cable assembly for a wireless charger device according to some embodiments.

FIG. 4 shows a cross-section view of a multi-stranded wire that can be used to form an inductive transmitter coil according to some embodiments.

FIG. 5 shows a simplified exploded view of an electronic device according to some embodiments.

FIG. 6 shows a cross-section view of a multi-stranded wire that can be used to form an inductive receiver coil according to some embodiments.

FIG. 7 shows a bottom view of a system electronics package for an electronic device according to some embodiments.

FIG. 8 shows a top view of an antenna assembly for an electronic device according to some embodiments.

### DETAILED DESCRIPTION

The following description of exemplary embodiments of the invention is presented for the purpose of illustration and description. It is not intended to be exhaustive or to limit the claimed invention to the precise form described, and persons skilled in the art will appreciate that many modifications and variations are possible. The embodiments have been chosen and described in order to best explain the principles of the invention and its practical applications to thereby enable others skilled in the art to best make and use the invention in various embodiments and with various modifications as are suited to the particular use contemplated.

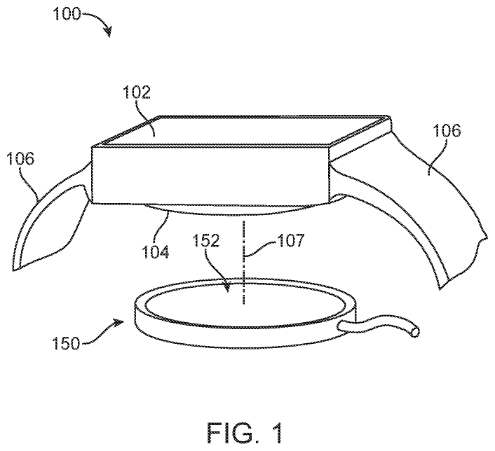

FIG. 1 shows a perspective view of an electronic device 100 and a wireless charger device 150 according to some embodiments. Electronic device 100 can include a housing 102 having a magnetically transparent window 104 formed on one surface (e.g., a rear surface). Window 104 can be made of materials such as crystal, glass or polymers, or any other material that permits the transmission of magnetic fields having a frequency in a range used for wireless power transfer (e.g., from about 300 kHz to about 2 MHz), while the rest of housing 102 can be made of other materials such as aluminum, steel, ceramic, or other materials that may or may not impede transmission of time-varying magnetic fields. Electronic device 100 can also include an electronic display 110 positioned on an opposite side of housing 102 from window 104. In some embodiments, electronic display 110 can take the form of a touch screen configured to display a graphical user interface to a user of electronic device 100. In this example, electronic device 100 can include a wristband 106 for securing electronic device 100 to a wrist of a user. While electronic device 100 is depicted as a wrist-wearable device it should be understood that wireless charging systems of the kind described herein can be incorporated into any type of rechargeable electronic device.

A wireless charger device 150 can be used to provide power to electronic device 100 using inductive power transfer. For example, wireless charger device 150 can include a transmitter coil (not shown in FIG. 1) and driver circuitry to generate an alternating current in the transmitter coil. Time-varying magnetic fields produced by the alternating current can exit wireless charger device 150 through a charging surface 152. Electronic device 100 can have a receiver coil (not shown in FIG. 1) disposed adjacent to window 104. In operation, wireless charger device 150 can drive the transmitter coil, thereby generating a time-varying magnetic field, e.g., an oscillating field having a particular frequency. The time-varying magnetic field can induce an electrical current in a receiver coil (not shown in FIG. 1) in electronic device 100, and the electrical current can be used to charge an internal battery of electronic device 100 and/or to supply power to other circuitry within electronic device 100.

Efficiency of wireless power transfer depends on a number of factors, including alignment between the transmitter and receiver coils. In some embodiments, wireless charger device 150 and electronic device 100 can include magnetic alignment components (not shown in FIG. 1) to attract and hold the transmitter and receiver coils in a desired alignment. For instance, the desired alignment may align the transmitter and receiver coils along a longitudinal axis 107.

In embodiments described herein, the transmitter coil of wireless charger device 150 can operate at either of two different operating frequencies, referred to herein as a “low” frequency and a “high” frequency. The low frequency can be in a range from about 300 kHz to about 400 kHz (e.g., about 326 kHz in some embodiments), and the high frequency can be in a range from about 1 MHz to about 2 MHz (e.g., about 1.78 MHz in some embodiments). Similarly, in embodiments described herein, the receiver coil of electronic device 100 can operate at either the high or low frequency. In some embodiments, the operating frequency for a particular pair of devices used together is determined dynamically, based on the capabilities of the devices. For example, it is contemplated that a family of electronic devices having similar form factors may be provided. The family may include “upgraded” electronic devices that can charge at either the high frequency or the low frequency, as well as “legacy” electronic devices that can charge only at the low frequency. Similarly, a family of wireless charger devices may include upgraded charger devices that can transmit power at either the high frequency or the low frequency and legacy charger devices that can transmit power only at the low frequency. An upgraded charger device can be used to provide power at the high frequency to an upgraded electronic device and to provide power at the low frequency to a legacy electronic device. Likewise, where an upgraded electronic device can receive power at either frequency, the upgraded electronic device can receive power at the high frequency from an upgraded charging device and can receive power at the low frequency from a legacy charging device. In this manner, upgraded electronic devices and chargers can be interoperable with legacy electronic devices and chargers.

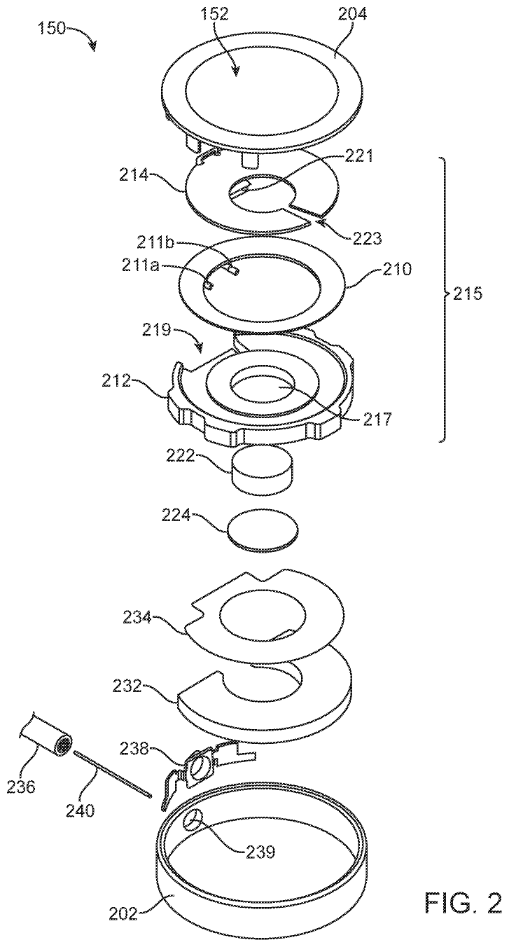

FIG. 2 shows an exploded view of wireless charger device 150 according to some embodiments. Wireless charger device 150 includes a housing base 202, which can be made of aluminum or other materials as desired. A cap 204 can be shaped to fit over the top of housing base 202 to form an enclosure. In this example, housing base 202 and cap 204 provide a puck-shaped form factor. The top surface of cap 204, which can define charging surface 152, can be planar or can have a non-planar (e.g., concave) portion to accommodate a nonplanar (e.g., convex) charging surface of an electronic device. Housing base 202 and cap 204 can be made of a variety of materials, including materials that are non-corrosive, chemically resistant, and capable of withstanding thermal and mechanical stress. For example, housing base 202 can be made of a metal, metal alloy, ceramic, plastic, or composite material. In various embodiments, housing base 202 can be made of stainless steel or aluminum. Cap 204 can be made of a material that allows time-varying magnetic fields generated within the enclosure formed by cap 204 and housing base 202 to pass through cap 204 with little or no loss. For example, cap 204 can be made of polycarbonate or other plastic, ceramic, or composite. In some embodiments, charging surface 152 can be coated with soft-touch silicone or the like, which can provide a softer contact surface and avoid marring the surface of the device being charged. Other materials that allow transmission of electromagnetic fields in the desired frequency ranges can also be used. In some embodiments, charging surface 152 can be a low-friction surface, and wireless charger device 150 can rely on magnetic forces rather than friction for maintaining alignment with a device to be charged. Housing base 202 and cap 204 can be sealed together using an adhesive (e.g., a resin) such that wireless charger device 150 is resistant to intrusion of liquids (e.g., water).

A charging coil assembly 215 can include a coil 210, an electromagnetic shield 214, and a ferrimagnetic sleeve 212. Coil 210 can be a coil formed of multiple turns of a multi-stranded copper wire (or other conductive and ductile material), with terminals 211a, 211b toward the center of the coil, having a proximal surface oriented toward cap 204 and an opposing distal surface. Further description of coil 210 is provided below.

Ferrimagnetic sleeve 212 can be positioned at the distal side of coil 210 (i.e., the side opposite cap 204). Ferrimagnetic sleeve 212 can be made of ferrimagnetic material (which can be, e.g., a ceramic material that includes iron oxide) with a magnetic permeability (μᵢ) that provides low loss at high charging frequencies (e.g., ˜2 MHz). For example, the ferrimagnetic material can be MnZn with μᵢ˜900. Ferrimagnetic sleeve 212 can be shaped to direct magnetic flux generated by coil 210 toward charging surface 152 and can also provide shielding against electromagnetic emissions through surfaces of wireless charger device 150 other than charging surface 152. The upper surface of ferrimagnetic sleeve 212 can be contoured to surround the distal and outer sides of coil 210. Ferrimagnetic sleeve and can have a central opening 217. A peripheral pass-through space 219 can be provided to accommodate coil terminals 211a, 211b. In some embodiments, electrically insulating material can be applied to portions of ferrimagnetic sleeve 212 to prevent ferrimagnetic sleeve from electrically contacting and shorting out charging coil 210.

Electromagnetic shield 214 can be disposed between cap 204 and coil 210 to provide a capacitive shield that helps to remove coupled noise between wireless charger device 150 and an electronic device being charged by wireless charger device 150, including noise that can occur as result of user interaction with a touch-sensitive display on the electronic device. In some embodiments, electromagnetic shield 214 can be made of thin and flexible materials. For example, electromagnetic shield 214 can be formed of a flexible printed circuit board with electrically-conductive material printed or otherwise deposited thereon. An adhesive layer can be provided to secure electromagnetic shield 214 in place. In other embodiments, electromagnetic shield 214 can be formed by printing conductive material onto a pressure-sensitive adhesive film. Electromagnetic shield 214 can include a tail 221 that can extend toward a surface of housing base 202 (e.g., the bottom surface) to provide electrical grounding. As shown, electromagnetic shield 214 can include a slit 223 to prevent eddy currents from forming.

Magnet 222 and DC shield 224 can provide a magnetic alignment structure that can attract a complementary magnetic alignment structure in a portable electronic device to be charged. For example, magnet 222 can be a cylindrical permanent magnet with an axial dipole orientation. DC shield 224 can be made of a material that directs magnetic flux from magnet 222 away from the bottom surface of housing base 202 so that the distal side of wireless charger device 150 is not strongly magnetized. The height of magnet 222 and DC shield 224 can be equal to a distance between cap 204 and the inner bottom surface of housing base 202, so that magnet 222 does not move axially within wireless charger device 150 and so that the proximal end of magnet 222 is adjacent to the inner surface of cap 204. Lateral movement of magnet 222 can be constrained by the size of central opening 217 in ferrimagnetic sleeve 212 and/or using other techniques such as adhesives or potting.

Heat sink 232 can be made of a thermally conductive and electrically inert material. In various embodiments, heat sink 232 can act as a spacer so that coil 210 is held in position proximate to cap 204, as a heat sink to pull heat generated during operation of coil 210 away from an electronic device being charged, and/or as an added mass for wireless charger device 150 to provide greater stability when wireless charger device 150 is resting on a surface. In some embodiments, heat sink 232 can be attached to the distal surface of ferrimagnetic sleeve 212 using a pressure sensitive adhesive 234 and can be connected to the common ground, e.g., via ferrimagnetic sleeve 212 and/or electromagnetic shield 214.

Power can be supplied to wireless charger device 150, and more particularly to coil 210, via an external cable 236 that passes through an opening 239 in the sidewall of housing base 202. In some embodiments, cable 236 supplies AC current directly to coil 210, and the enclosure of wireless charger device 150 need not include any active electronic components or circuits. A metal puck crimp 238 can be provided to secure cable 236 in the enclosure and to electrically couple a ground wire of cable 236 to housing base 202. In some embodiments, cable 236 is captively secured and is not user-detachable from housing base 202. Conductive wires within cable 236 that carry an AC current can be connected to terminals 211a, 211b of coil 210, e.g., by routing the wires through pass-through space 219 of ferrimagnetic sleeve 212. Strain relief can be provided using an internal strain relief element 240 (which can be a stiff section of nonconductive material) or an external strain-relief sleeve, or using other techniques.

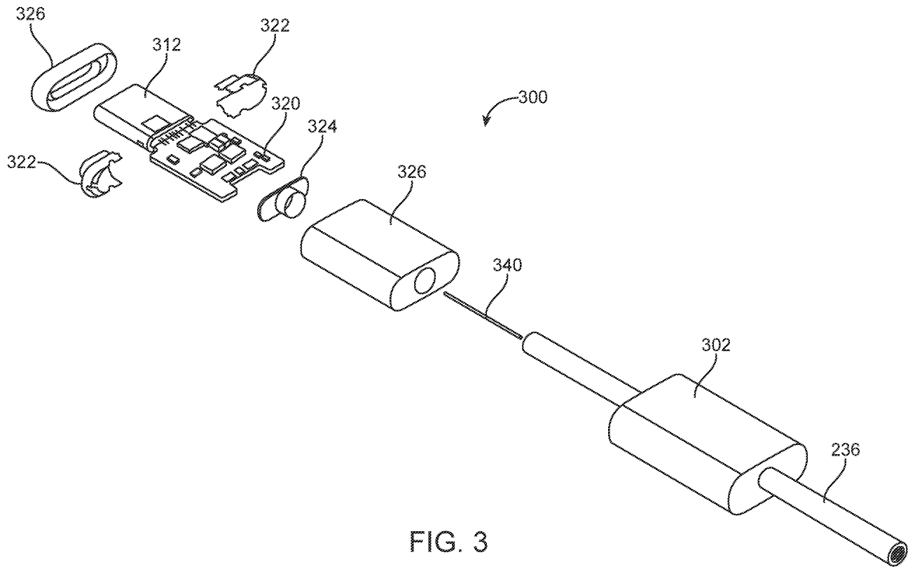

In embodiments where cable 236 supplies AC power directly to coil 210, electronic control circuitry can be provided externally to housing base 202. External control circuitry can help with thermal management. FIG. 3 shows an exploded view of a cable assembly 300 that can be attached to wireless charger device 150 according to some embodiments. Cable assembly 300 includes cable 236, one end of which can be secured to wireless charger device 150 as described above. The other end of cable 236 can terminate in a cable boot 302. Cable 236 can be as long as desired (e.g., 1 meter, 2 meters, or other length). Cable boot 302 can be made of electrically nonconductive material (e.g., plastic, ceramic, polymer, resin) and can have an esthetically pleasing appearance. Cable boot 302 can house a main logic board 320. Main logic board 320 can be coupled to a connector 312, which can be, e.g., a plug-type Universal Serial Bus (USB) connector such as a Type A or Type C USB connector. Connector 312 can include electrical contacts for power, ground, and data (e.g., USB D+ and D− data signals). Main logic board 320 can be a printed circuit board with active electronic components mounted thereon. The active electronic components can include a DC-to-AC converter (e.g., an inverter) that converts a received DC current to an AC current, which can be carried on a pair of wires through cable 236 to coil 210. The active electronic components can also include control circuitry to manage operation of the DC-to-AC converter, including determining whether to operate at the high frequency or the low frequency. In some embodiments, the control circuitry can include monitoring circuitry that monitors power transfer to the receiving device (which may include receiving signals from the receiving device, e.g., via modulation by the receiving device of the electromagnetic field that transfers power to the receiving device), and the selection of operating frequency can be based on the monitoring. Other techniques for selecting an operating frequency can also be used.

An electromagnetic shield 326 (also referred to as an “EMI shield”) can be disposed within cable boot 302 surrounding main logic board 320. EMI shield 326 can reduce or prevent electromagnetic interference between the circuitry of main logic board 320 (including the DC-to-AC converter) and other electronic equipment. EMI shield 326 can be made of various materials including conductive and/or magnetic materials. In some embodiments, EMI shield 326 can be constructed as a Faraday cage. EMI shield 326 and connector 312 can be connected to a common ground for wireless charger device 150, which can also be connected via cable 236 to housing base 202 as described above with reference to FIG. 2. Claim shell elements 322 can be made of plastic or other electrically insulating material and shaped to secure main logic board 320 in place within EMI shield 326. A boot crimp 324 can hold the distal end of cable 236 in place where cable 236 exits boot 302. Strain relief can be provided using an internal strain relief element 340 (which can be a stiff section of nonconductive material) or an external strain-relief sleeve, or using other techniques.

Coil 210 can be capable of operating at high efficiency at two different fundamental frequencies. In some embodiments, the low frequency can be in a range from about 300 kHz to about 400 kHz (e.g., a frequency of 326 kHz), and the high frequency can be in a range from about 1 MHz to about 2 MHz (e.g., a frequency of about 1.78 MHz). As noted above, coil 210 can be formed from a conductive wire wound into multiple turns to form a coil. When alternating current flows through a conductor, the current density tends to be highest near the surface and decrease exponentially nearer the center of the conductor; this is referred to as the “skin effect.” Skin effect, which increases the effective resistance of the conductor, becomes more pronounced as frequency increases, resulting in less efficient operation.

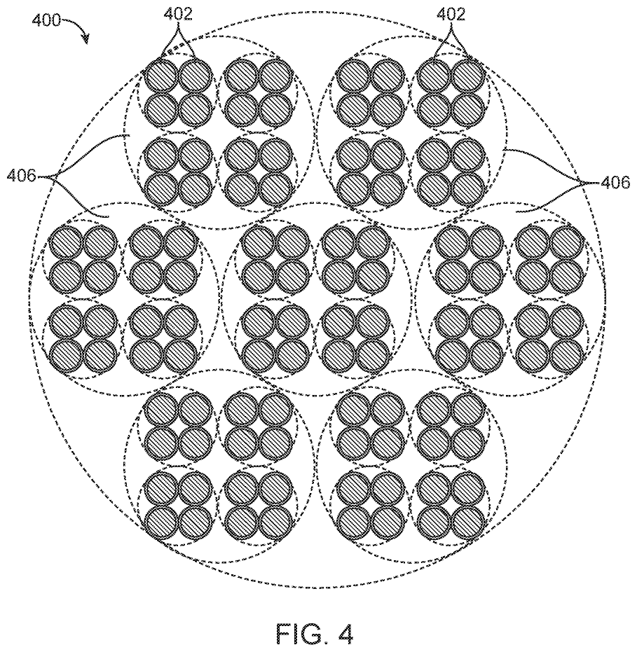

To support efficient operation at high frequency, coil 210 in some embodiments can be made of a compound (multi-stranded) wire. FIG. 4 shows a cross-section view of a multi-stranded wire 400 that can be used to form coil 210 according to some embodiments. Wire 400 is made of many individual strands 402. Each strand 402 can be an extruded length of copper wire (or other electrically conductive and ductile material) having a narrow diameter (e.g., 30 μm, or a diameter in a range from 20-40 μm). Each strand 402 can have an electrically insulating outer layer; for instance, each strand can be coated with a flexible insulating coating or wrapped in an insulating sleeve or jacket. A group of strands 402 can be twisted together to form a basic bundle 404. In the example shown in FIG. 4, each basic bundle 404 includes four strands 402. A group of basic bundles 404 can be twisted together to form a compound bundle 406. In the example shown, each compound bundle 406 includes four basic bundles 404, for a total of sixteen strands per compound bundle 406. A group of compound bundles 406 can be twisted together to form multi-stranded wire 400. In the example shown in FIG. 4, multi-stranded wire 400 includes seven compound bundles 406, for a total of 112 strands in multi-stranded wire 400. A wire formed in this manner increases the effective “skin” area, allowing for more efficient operation at a high frequency (e.g., around 1.78 MHz) while still providing efficient operation at a low frequency (e.g., around 326 kHz).

Coil 210 can be formed by winding multi-stranded wire 400 in multiple turns to form the the desired coil shape. In some embodiments, coil 210 includes one layer of windings in a spiral pattern; however multiple layers of windings can be provided if desired. All windings can lie in the same plane, or coil 210 can have a non-planar shape, e.g., conforming to a concave or other non-planar charging surface 152 of cap 204. In some embodiments, the outer end of wire 400 can cross to the inside of coil 210 so that terminals 211a, 211b are both inboard of the windings (as shown in FIG. 2); for instance, the outer end of wire 400 can be routed across the distal side of coil 210.

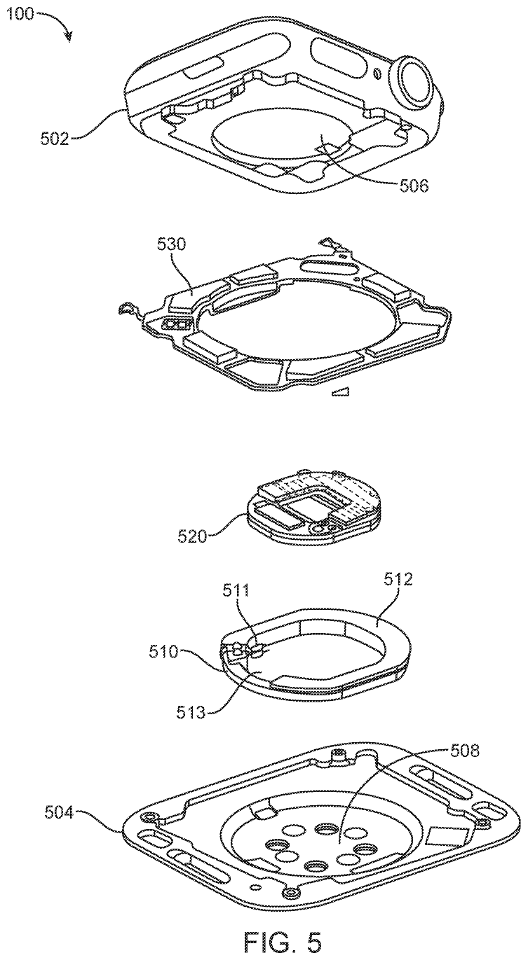

FIG. 5 shows a simplified exploded view of an electronic device 100 according to some embodiments. Electronic device 100 can include a main housing 502 and a rear housing 504 that define an enclosure. The enclosure can contain active electronic components such as a processor, memory, speakers, and so on, as well as a battery for electronic device 100 and charging circuitry that controls charging of the battery. In some embodiments, some or all of the active electronic components can be incorporated into a system electronics package 506. User interface components, such as a touchscreen display, buttons, dials, or the like, can be disposed on or form portions of the surfaces of main housing 502 and can be electrically coupled to system electronics package 506. Rear housing 504 can include a sensor window 508, which can be made of glass, ceramic, or other material that allows time-varying magnetic fields to pass through. In some embodiments, sensor window 508 can include optically transparent portions to allow optical sensors to operate through sensor window 508. Other portions of rear housing 504 and main housing 502 can be made of other materials such as aluminum, stainless steel, ceramic, composite materials, or the like.

Inductive charging receiver coil 510 can be positioned adjacent to sensor window 504. Coil 510 can be a coil of multi-stranded copper wire (or other electrically conductive and ductile material) having a proximal surface oriented toward sensor window 504 and an opposing distal surface. Terminals 511 can be provided to couple coil 510 to the charging circuitry of electronic device 100, which can be incorporated into system electronics package 506 or housed elsewhere in the enclosure defined by main housing 502 and rear housing 504.

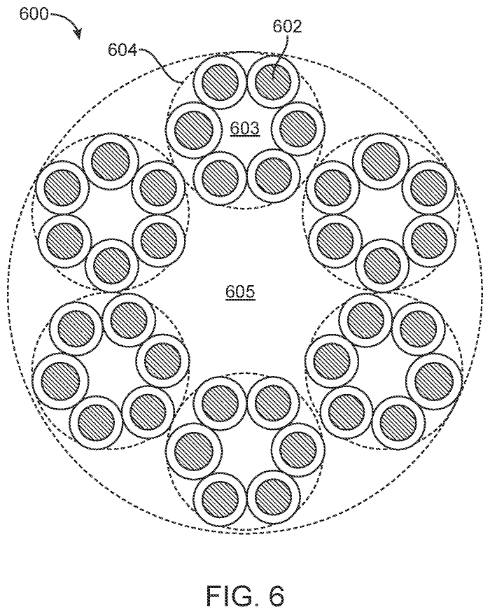

As with transmitter coil 210, receiver coil 510 can be formed of a multi-stranded wire to provide high efficiency at both operating frequencies. FIG. 6 shows a cross-section view of a multi-stranded wire 600 that can be used to form coil 510 according to some embodiments. Wire 600 is made of many individual strands 602. Each strand 602 can be an extruded length of copper wire (or other electrically conductive and ductile material) having a narrow diameter (e.g., 30 μm, or a diameter in a range from 20-40 μm). Each strand 602 can be coated or covered with a flexible insulating coating or sleeve. A group of strands 602 can be twisted together to form a bundle 604. In the example shown in FIG. 6, each bundle 604 includes six strands 602. In some embodiments, a non-conductive strand having approximately the same diameter as strands 602 can be placed in the center region 603 of bundle 604 to provide a non-conductive core, and conductive strands 602 can be twisted around the non-conductive core. In other embodiments, a non-conductive core can be omitted and center region 603 can simply be an air gap. A group of bundles 604 can be twisted together to form multi-stranded wire 600. In the example shown in FIG. 6, multi-stranded wire 600 includes six bundles 604, for a total of 36 strands in multi-stranded wire 600. In some embodiments, a non-conductive strand having approximately the same diameter as one of bundles 604 can be placed in the center region 605 of wire 600 to provide a non-conductive core, and bundles 604 can be twisted around the non-conductive core. In other embodiments, a non-conductive core can be omitted and center region 605 can simply be an air gap. Various embodiments can use a non-conductive core for the bundles and/or for the wire, or for neither. In some embodiments, a seventh conductive strand 602 can be included in each bundle 604, and/or a seventh bundle 604 can be included in wire 600. As with wire 400, a wire formed in the manner shown in FIG. 6 increases the effective “skin” area, allowing for more efficient operation at a high frequency (e.g., around 1.78 MHz) while still providing efficient operation at a low frequency (e.g., around 326 kHz).

Coil 510 can be formed by winding multi-stranded wire 600 in multiple turns to form the desired coil shape. In some embodiments, coil 510 includes one layer of windings in a spiral pattern; however multiple layers of windings can be provided if desired. All windings can lie in the same plane, or coil 510 can have a non-planar shape, e.g., conforming to a concave or other non-planar surface of sensor window 508. In some embodiments, the outer end of wire 600 can cross to the inside of coil 510 so that terminals 511 are both inboard of the windings (as shown in FIG. 5); for instance, the outer end of wire 600 can be routed across the distal side of coil 510.

Referring again to FIG. 5, ferrimagnetic shield 512 can be positioned at the distal side of coil 510. Ferrimagnetic shield 512 can be made of ferrimagnetic material (which can be, e.g., a ceramic material that includes iron oxide) with magnetic permeability μᵢ that provides low loss at high charging frequencies (e.g., ˜2 MHz). For example, the ferrimagnetic material can be MnZn with μᵢ˜900. Ferrimagnetic shield 512 can be shaped to concentrate magnetic flux into coil 510 and can also provide shielding of other components of electronic device 100 against electromagnetic emissions through surfaces of electronic device 100 other than the charging surface provided by sensor window 508. For example, a sensor electronics module 520 can be disposed inboard of coil 510. Sensor electronics module 520 can include various components that provide sensors for the external environment, including, for instance, optical sensors that can operate through sensor window 508. In some embodiments, ferrimagnetic shield 512 can extend over the inboard side surface of coil 510 and can help to prevent electromagnetic interference between coil 510 and sensor electronics module 520. In some embodiments, ferrimagnetic shield 512 can include a gap region 513 where a portion of coil 510 is exposed.

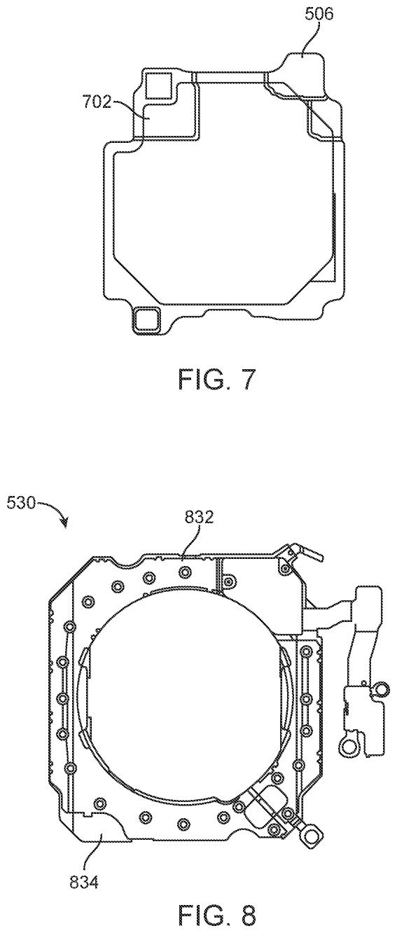

In some embodiments, additional shielding can be provided between coil 510 and system electronics package 506. By way of example, FIG. 7 shows a bottom view of system electronics package 506 according to some embodiments. A copper tape (or other conductive tape) 702 can be applied to cover the surface of system electronics package 506 to provide additional shielding. In some embodiments, copper tape 702 can cover all or nearly all of the surface of system electronics package 506 that is oriented toward coil 510, including the portion of the surface that is inboard of coil 510. Other conductive materials can be substituted for copper tape 702.

Referring again to FIG. 5, in some embodiments, an antenna assembly 530 can be disposed outboard of (i.e., around the outer perimeter of) coil 510 inside rear housing 504. Antenna assembly 530 can be electrically connected to system electronics package 506 and can be used by electronic device 100 to send and receive data signals, which may be unrelated to wireless charging. In some embodiments, antenna assembly 530 can be constructed to reduce electromagnetic interference between coil 510 and antenna assembly 530. For instance, as shown in FIG. 8, antenna assembly 530 can include a conductive antenna body 832 and a retaining structure 834, which can be made of plastic or other rigid and electrically insulating material. Antenna body 832 can be a planar structure that is formed, e.g., by stamping of a copper or other metal foil into a desired planar antenna geometry, and retaining structure 834 can be formed around antenna body 832 using an injection molding process. Injection molding can provide for a thicker antenna body as compared to deposition processes, and a thicker antenna body 832 can improve performance of coil 510. For instance, antenna body 832 can have a thickness of approximately 80 μm.

In embodiments described above, wireless charger device 150 can operate coil 210 to provide power at either a low frequency (e.g., a frequency of about 326 kHz or other frequency in the range from about 300 kHz to about 400 kHz) or a high frequency (e.g., a frequency of about of 1.78 MHz or other frequency in the range from about 1.5 MHz to about 2 MHz). Similarly, electronic device 100 can receive power via coil 510 at either the low frequency or the high frequency. In some embodiments, power transfer efficiency can be around 70% at the low frequency and around 85% at the high frequency. The coil configurations described above provide more efficient magnetic coupling at the high frequency than the low frequency, although the associated electronics may operate slightly less efficiently at the high frequency. In some embodiments, the increased magnetic coupling efficiency at the high frequency can result in significant reductions (e.g., 25% to 50%) in time needed to charge a battery of the portable electronic device at the high frequency as compared to charging at the low frequency. In some embodiments, wireless charger device 150 operates at the high frequency when providing power to a device capable of receiving power at the high frequency and switches to the low frequency when providing power to other devices (e.g., legacy devices as described above). In some embodiments, electronic device 100 receives power at either frequency depending on which frequency a particular wireless charger is providing at a given time.

While the invention has been described with reference to specific embodiments, those skilled in the art will appreciate that variations and modifications are possible. For instance, the wireless charging systems described herein are designed to be compact so that the receiver coil can fit into a portable electronic device with a small form factor such as a wristwatch. Similarly, a wireless charger device can be small and lightweight so that it is easy to transport from place to place where charging may be desired. However, wireless power transmitter and receiver systems of the kind described herein can be incorporated into any portable electronic device regardless of form factor or particular supported functionality. All dimensions and materials mentioned herein are for purposes of illustration and can be modified. The number of strands in a bundle and number of bundles in a wire can also be varied. Using twisted strands to form a compound wire can simplify manufacturing.

Accordingly, although the invention has been described with respect to specific embodiments, it will be appreciated that the invention is intended to cover all modifications and equivalents within the scope of the following claims.

What is claimed is:

1. A wireless charger device comprising:
a coil formed of a compound wire wound into a plurality of turns,
wherein the compound wire comprises a plurality of strands, wherein groups of the strands are twisted around each other to form a set of basic bundles, wherein groups of basic bundles are twisted around each other to form a plurality of compound bundles, and wherein the plurality of compound bundles are twisted around each other to form the compound wire, and
control circuitry coupled to the coil and configured to generate an alternating current in the compound wire at a low frequency in a range between 300 kHz and 400 kHz and at a high frequency in a range between 1 MHz and 2 MHz.

2. The wireless charger device of claim 1 wherein each basic bundle includes four strands.

3. The wireless charging device of claim 2 wherein each strand is a copper wire having an electrically insulating outer layer and a diameter of about 30 μm.

4. The wireless charger device of claim 2 wherein each compound bundle includes four basic bundles.

5. The wireless charger device of claim 4 wherein the compound wire includes seven compound bundles.

6. The wireless charger device of claim 1 wherein the plurality of turns of the compound wire are arranged in a single layer.

7. A wireless charger device comprising:
a housing including a cap and a housing base forming an enclosure;
a coil formed of a compound wire wound into a plurality of turns, the coil being disposed within the enclosure and proximate to the cap,
wherein the compound wire comprises a plurality of strands, wherein groups of the strands are twisted around each other to form a set of basic bundles, wherein groups of basic bundles are twisted around each other to form a plurality of compound bundles, and wherein the plurality of compound bundles are twisted around each other to form the compound wire; and
control circuitry coupled to the coil and configured to generate an alternating current in the compound wire at a low frequency in a range between 300 kHz and 400 kHz and at a high frequency in a range between 1 MHz and 2 MHz.

8. The wireless charger device of claim 7 further comprising:
an external cable connected to the housing, the external cable including a cable boot,
wherein the control circuitry is disposed in the cable boot and the external cable transfers the alternating current between the cable boot and the coil.

9. The wireless charger device of claim 7 wherein each basic bundle includes four strands.

10. The wireless charger device of claim 9 wherein each compound bundle includes four basic bundles.

11. The wireless charger device of claim 10 wherein the compound wire includes seven compound bundles.

12. The wireless charger device of claim 7 further comprising:
a ferrimagnetic sleeve disposed around a distal surface of the coil; and
an electromagnetic shield disposed between a proximal surface of the coil and the cap.

13. The wireless charger device of claim 7 wherein the low frequency is 326 kHz and the high frequency is 1.78 MHz.

14. An electronic device comprising:
a main housing and a rear housing forming an enclosure;
a battery disposed within the enclosure; and
a coil made of a compound wire wound into a plurality of turns and disposed within the enclosure and proximate to the rear housing,
wherein the compound wire comprises a plurality of strands, wherein groups of the strands are twisted around each other to form a plurality of bundles and wherein the bundles are twisted around each other to form the compound wire,
wherein the coil is configured to generate an alternating current in the compound wire in response to a magnetic field having a first frequency in a range between 300 kHz and 400 kHz and in response to an external magnetic field having a second frequency in a range between 1 MHz and 2 MHz, and wherein the alternating current in the compound wire is used to charge the battery.

15. The electronic device of claim 14 wherein each bundle includes six strands.

16. The electronic device of claim 15 wherein the compound wire includes six bundles.

17. The electronic device of claim 14 further comprising:
a system electronics package disposed within the enclosure; and
a conductive tape disposed on a surface of the system electronics package that is oriented toward the coil.

18. The electronic device of claim 14 further comprising:
an antenna assembly disposed outboard of the coil,
wherein the antenna assembly includes a planar conductive antenna body and an injection-molded plastic retaining structure around the antenna body.

19. The electronic device of claim 14 further comprising:
a ferrimagnetic shield disposed around a distal surface of the coil.

20. The electronic device of claim 19 further comprising:
a sensor electronics module disposed inboard of the coil, wherein the ferrimagnetic shield extends over an inboard side surface of the coil.
